(19) United States
(12) Patent Application Publication
(10) Pub. No.: US 2024/0112480 A1
(43) Pub. Date: Apr. 4, 2024

(54) METHOD FOR PUBLISHING IMAGE AND ELECTRONIC DEVICE

(71) Applicant: BEIJING DAJIA INTERNET INFORMATION TECHNOLOGY CO., LTD., Beijing (CN)

(72) Inventor: Qian SHAO, Beijing (CN)

(21) Appl. No.: 18/470,164

(22) Filed: Sep. 19, 2023

(30) Foreign Application Priority Data
Sep. 29, 2022 (CN) 202211204859.5

(51) Int. Cl. G06V 20/70; G06F 40/106; G06T 7/00; G06V 10/762; G06V 10/94

(52) U.S. Cl. CPC G06V 20/70; G06F 40/106; G06T 7/0002; G06V 10/762; G06V 10/945; G06T 2207/20092; G06T 2207/30168

(57) ABSTRACT

Provided is a method for publishing an image by an electronic device. The method comprises: displaying, in response to an image selection instruction, a plurality of images on an image selection page; displaying, in response to a selection operation on a first image on the image selection page, the first image and at least one second image on an image preview page; and publishing, in response to an image publishing instruction, at least one image selected on the image preview page.

This application is based on and claims priority to Chinese Patent Application No. 202211204859.5, filed on Sep. 29, 2022, the disclosure of which is herein incorporated by reference in its entirety.

### TECHNICAL FIELD

The present disclosure relates to the field of Internet technologies, and in particular, relates to a method for publishing an image and an electronic device.

### BACKGROUND

With the development of Internet technology, users can publish works such as image works on the Internet. To publish image work, the users may need to review multiple images in an album, and then select one or more images and publish the image work.

### SUMMARY

The present disclosure provides a method for publishing an image and an electronic device.

According to an aspect of the embodiments of the present disclosure, a method for publishing an image is provided. The method includes:
displaying, in response to an image selection instruction, a plurality of images on an image selection page;
displaying, in response to a selection operation on a first image on the image selection page, the first image and at least one second image on an image preview page, wherein the first image is any one of the plurality of images, and the second image is an associated image including a same subject object as the first image; and
publishing, in response to an image publishing instruction, at least one image selected on the image preview page.

According to another aspect of the embodiments of the present disclosure, an electronic device is provided. The electronic device includes:
one or more processors; and
a memory for storing a program code executed by the one or more processors;
wherein the one or more processors are configured to execute the program code to perform:
displaying, in response to an image selection instruction, a plurality of images on an image selection page;
displaying, in response to a selection operation on a first image on the image selection page, the first image and at least one second image on an image preview page, wherein the first image is any one of the plurality of images, and the second image is an associated image including a same subject object as the first image; and
publishing, in response to an image publishing instruction, at least one image selected on the image preview page.

According to another aspect of the embodiments of the present disclosure, a computer-readable storage medium for storing a program code is provided. The program code, when executed by a processor of an electronic device, causes the electronic device to perform:
displaying, in response to an image selection instruction, a plurality of images on an image selection page;
displaying, in response to a selection operation on a first image on the image selection page, the first image and at least one second image on an image preview page, wherein the first image is any one of the plurality of images, and the second image is an associated image including a same subject object as the first image; and
publishing, in response to an image publishing instruction, at least one image selected on the image preview page.

According to another aspect of the embodiments of the present disclosure, a computer program product including a computer program is provided. The computer program, when executed by a processor, causes the electronic device to perform:
displaying, in response to an image selection instruction, a plurality of images on an image selection page;
displaying, in response to a selection operation on a first image on the image selection page, the first image and at least one second image on an image preview page, wherein the first image is any one of the plurality of images, and the second image is an associated image including a same subject object as the first image; and
publishing, in response to an image publishing instruction, at least one image selected on the image preview page.

### BRIEF DESCRIPTION OF THE DRAWINGS

FIG. 1 is a schematic diagram of an environment for implementing a method for publishing an image according to some embodiments.

FIG. 2 is a flowchart of a method for publishing an image according to some embodiments.

FIG. 3 is a flowchart of another method for publishing an image according to some embodiments.

FIG. 4 is a schematic diagram of an image selection page according to some embodiments.

FIG. 5 is a schematic diagram of an image preview page according to some embodiments.

FIG. 6 is a schematic diagram of a clicking operation on an image switching area according to some embodiments.

FIG. 7 is a schematic diagram of a sliding operation on an image switching area according to some embodiments.

FIG. 8 is a schematic diagram of a sliding operation on an image preview page according to some embodiments.

FIG. 9 is a schematic diagram of a selected image state according to some embodiments.

FIG. 10 is a schematic diagram of a clicking operation and a re-clicking operation on a blank area according to some embodiments.

FIG. 11 is a block diagram of an apparatus for publishing an image according to some embodiments.

FIG. 12 is a block diagram of another apparatus for publishing an image according to some embodiments.

FIG. 13 is a block diagram of an electronic device according to some embodiments.

FIG. 14 is a schematic structural diagram of a server according to some embodiments.

### DETAILED DESCRIPTION

It should be noted that the information (including, but not limited to, user device information, user personal information, etc.), data (including, but not limited to, data for analysis, stored data, displayed data, etc.) and signals, which are referred to in the present disclosure, are authorized by the user or fully authorized by various parties, and the collection, use and processing of the relevant data are required to comply with relevant laws and regulations and standards in relevant countries and regions.

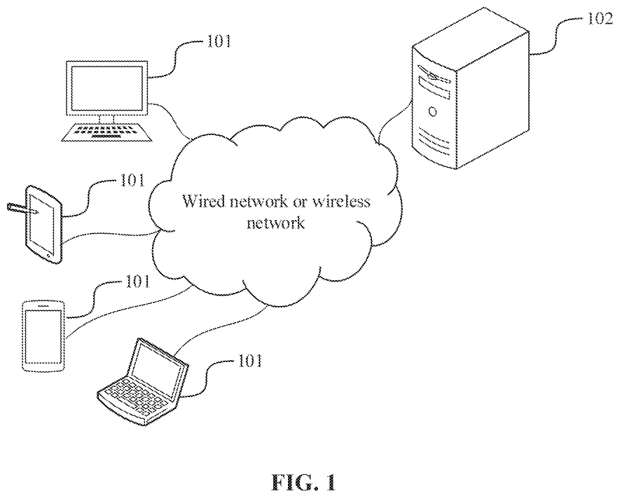

FIG. 1 is a schematic diagram of an environment for implementing a method for publishing an image according to some embodiments. Referring to FIG. 1, the implementation environment includes a terminal 101 and a server 102.

The terminal 101 may be an electronic device. For example, the terminal may be at least one of a smart phone, a smart watch, a desktop computer, a laptop computer, a moving picture experts group audio layer III (MP3) player, a moving picture experts group audio layer IV (MP4) player, a laptop portable computer, and other devices. An application for publishing images is installed and run on the terminal 101. The terminal 101 is connected with the server 102 via a wireless network or a wired network.

The terminal 101 is generally referred to as one of a plurality of terminals, and this embodiment only illustrates the terminal 101. Those skilled in the art appreciate that the number of the terminals described above is greater or less. For example, the number of the terminals described above is only a few, or dozens, or hundreds, or even more, and the number of the terminals and the type of the devices are not limited in the embodiments of the present disclosure.

The server 102 is at least one of a server, a plurality of servers, a cloud computing platform, and a virtualization center. The server 102 is connected with the terminal 101 and other terminals via a wireless network or a wired network. In some embodiments, the number of the servers described above is more or less, which is not limited in the embodiments of the present disclosure. The server 102 also includes other functional servers to provide more comprehensive and diverse services.

In the related art, in the case that a user wants to publish an image work in an application for publishing images, images can be sequentially viewed through the album and then one or more images are selected for publishing. However, as a plurality of similar images may exist in the album, it is difficult to screen the similar images, such that it takes a lot of time for a user to view and select, resulting in inefficient publishing of the images.

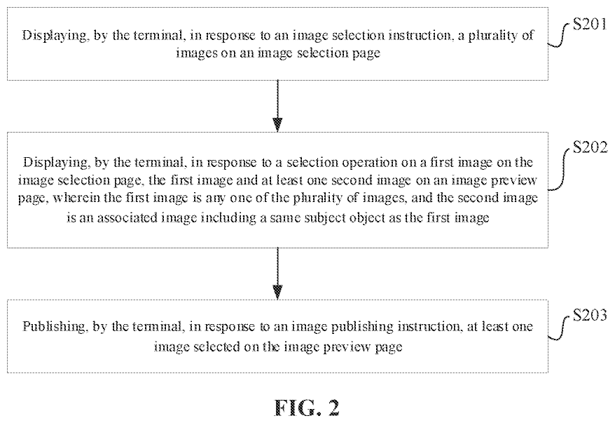

FIG. 2 is a flowchart of a method for publishing an image according to some embodiments. As shown in FIG. 2, the method is performed by a terminal and includes the following processes S201 to S203.

In S201, the terminal displays, in response to an image selection instruction, a plurality of images on an image selection page.

In the embodiments of the present disclosure, before a use object publishes an image, the image selection instruction is triggered by a use object to cause the terminal to display the image selection page, and then the plurality of images displayed on the image selection page are selected. The image selection page displays a plurality of images, wherein the plurality of images may include many similar images, and it may take the use object a lot of time to distinguish the similar images to find the images for selection, thus the terminal needs to process the similar images to increase the efficiency when the images are selected by the use object.

In S202, the terminal displays, in response to a selection operation on a first image on the image selection page, the first image and at least one second image on an image preview page, wherein the first image is any one of the plurality of images, and the second image is an associated image including a same subject object as the first image.

In the embodiments of the present disclosure, the subject object is an object mainly represented by an image, that is, an object with the largest area ratio in the image. The subject object may also be the foremost object in the image, or an object located in the center of the image. The second image is an associated image of the first image, that is, the second image and the first image may be images acquired by shooting the same subject object from different angles, by shooting different movements of the same subject object, or by shooting the same subject object in different imaging modes, which is not limited in the embodiments of the present disclosure. After the use object selects the first image from the plurality of images displayed on the image selection page, the terminal displays the image preview page. The use object can preview the selected first image and at least one second image including the same subject object as the first image on the image preview page. The use object, when previewing the images, can select at least one to-be-published image according to the display effect of different images including the same subject object. Through the display of the first image and the at least one second image on the preview page, the images are preliminarily screened or filtered such that the use object can preview and select the images easily and increase the image publishing efficiency.

In some embodiments, the appropriate methods known in the art can be used to identify the associated images or the second images including the same subject object as the first image. For example, a neural network trained for image recognition may be used to recognize the images containing the same subject object. According to the recognition result, the terminal displays the images having the same subject object.

In S203, the terminal publishes, in response to an image publishing instruction, at least one image selected on the image preview page.

In the embodiments of the present disclosure, after the use object previews the similar images on the image preview page and then selects at least one to-be-published image, the use object can trigger the image publishing instruction. The terminal publishes, in response to the image publishing instruction, the at least one image selected by the use object.

The embodiments of the present disclosure provide the method for publishing the image. In response to the image selection instruction, the image selection page is displayed; after the use object selects the first image on the image selection page, the first image selected by the use object and at least one second image having the same subject object as the first image is displayed on the image preview page; and then the use object selects at least one image on the image preview page for image publishing. As the images are screened before displaying for selection, the time needed for image selection can be reduced, and thus increasing the image publishing efficiency.

In some embodiments, the plurality of images on the image preview page are further processed by adding one or more labels. The labels may be configured to assist the selection of the images for preview. The label may be configured to indicate that an image with the label is different from other images. The different labels may be added to assist the selection of an image and/or recommend an image for selection.

In some embodiments, displaying, in response to the image selection instruction, the plurality of images on the image selection page includes:
adding, in response to the image selection instruction, a label to at least one image in the plurality of images; and
displaying the at least one image with the label and at least one image without the label on the image selection page.

By adding the label to the at least one image, the at least one image can be recommended to the use object when the use object selects an image, thereby increasing the efficiency of image selection by the use object.

In some embodiments, adding, in response to the image selection instruction, the label to the at least one image in the plurality of images includes:
displaying, in response to the image selection instruction, the plurality of images on a label adding page, wherein the label adding page is configured to add custom labels to the plurality of images; and
adding, in response to a label adding operation on any one of the plurality of images, a first label to the image.

By adding the custom labels to the plurality of images, the personalized identification of the images can be achieved for the use object, and at least one image can be recommended to the use object when the use object selects an image, thereby increasing the efficiency of image selection by the use object.

In some embodiments, adding, in response to the image selection instruction, the label to the at least one image in the plurality of images includes:
acquiring, in response to the image selection instruction, image attributes of the plurality of images, wherein the image attribute is configured to represent a type of a subject object in an image; and
adding, for any one of the plurality of images, a second label to the image based on an image attribute of the image.

By adding the label to the image based on the image attribute of the image, the type of the image is visually seen when the use object selects an image, thereby increasing the efficiency of image selection by the use object.

In some embodiments, adding, in response to the image selection instruction, the label to the at least one image in the plurality of images includes:
acquiring, in response to the image selection instruction, a historical published image of a use object, wherein the use object is an object triggering the image selection instruction, and the historical published image is an image published by the use object in a historical period of time;
predicting, based on an image attribute of the historical published image, the at least one image published this time, wherein the image attribute is configured to represent a type of a subject object in an image; and
adding a third label to the at least one image.

By adding the label to the image published this time based on the historical published image of the use object, an image of the same type as the historical published image can be recommended to the use object when the use object selects an image, thereby increasing the efficiency of image selection by the use object.

In some embodiments, the plurality of images are divided into at least one similar image group, the similar image group including a plurality of images similar to each other; and
adding, in response to the image selection instruction, the label to the at least one image in the plurality of images includes:
acquiring, in response to the image selection instruction, quality parameters of the plurality of images, wherein the quality parameter is configured to represent a quality of an image; and
adding, for any similar image group, a fourth label to an image with a quality parameter greater than a parameter threshold in the similar image group.

By adding the label to the images based on the quality parameters, an image with higher quality can be recommended to the use object when the use object selects an image, thereby increasing the efficiency of image selection by the use object.

In some embodiments, the method further includes:
determining, for any one of the plurality of images, a definition parameter of the image, wherein the definition parameter is configured to represent a definition degree of an image;
determining a picture parameter of the image, wherein the picture parameter is configured to represent a highlighting degree of a subject object in an image; and
determining, based on the definition parameter and the picture parameter, a quality parameter of the image.

The quality parameters are determined based on the definition parameters and the picture parameters, such that the image obtained by screening has a high definition, and the subject object of the image is highlighted, thereby increasing the efficiency of image selection by the use object.

In some embodiments, displaying, in response to the selection operation on the first image on the image selection page, the first image and the at least one second image on the image preview page includes:
determining, in response to the selection operation on the first image on the image selection page, a sum value of a first number and a second number, wherein the first number is a number of the first image, and the second number is a number of the at least one second image;
displaying, in a case that the sum value falls within a preset range, the first image and the at least one second image on the image preview page; and
displaying, in a case that the sum value does not fall within the preset range, the first image on the image preview page.

Through the comparison of the sum value with the preset range, the terminal displays different images on the image preview page.

In some embodiments, displaying, in response to the selection operation on the first image on the image selection page, the first image and the at least one second image on the image preview page includes:
displaying, in response to the selection operation on the first image on the image selection page, the first image and an image switching area on the image preview page; and
displaying the first image and the at least one second image in a form of thumbnails in the image switching area.

The first image and the at least one second image are displayed in the form of thumbnails in the image switching area, such that the use object switches the images in the image switching area, thereby increasing the efficiency of image selection by the use object.

In some embodiments, the method further includes:
displaying, in response to a clicking operation on a thumbnail of any second image in the image switching area, the second image on the image preview page; or
displaying, in response to a sliding operation on the image switching area, a second image corresponding to a thumbnail indicated by the sliding operation on the image preview page; or
displaying, in response to a sliding operation on the image preview page, a second image adjacent to the first image on the image preview page.

By performing operations on the image switching area and the image preview page, the image can be previewed and displayed, thereby increasing the efficiency of image selection by the use object.

In some embodiments, the method further includes:
canceling, in response to a clicking operation on a blank area on the image preview page, the display of other contents except a current image on the image preview page, wherein the current image is the first image or any second image; and
resuming, in response to a re-clicking operation on the blank area on the image preview page, the display of the other contents except the current image on the image preview page.

The different display effects of the image preview page are acquired by performing operations on the blank area, such that the use object visually previews the images, thereby increasing the efficiency of image selection by the use object.

In some embodiments, the method further includes:
determining, for any one of the plurality of images, at least one third image adjacent to a storage order of the image; and
determining, from the at least one third image, at least one associated image of the image, wherein the associated image has a same subject object as the image.

By acquiring the associated image based on the storage order of the image, the screening of the similar images is achieved, thereby increasing the efficiency of image selection by the use object.

In some embodiments, the method further includes:
determining, for any one of the plurality of images, at least one fourth image in a same time range as a storage period of time of the image; and
determining, from the at least one fourth image, at least one associated image of the image, wherein the associated image has a same subject object as the image.

By acquiring the associated image based on the storage period of time of the image, the screening of the similar images is achieved, thereby increasing the efficiency of image selection by the use object.

In some embodiments, the method further includes:
acquiring a plurality of image clusters by clustering the plurality of images; and
determining a plurality of images belonging to a same image cluster as mutually associated images.

By acquiring the mutually associated images through clustering the images, the screening of the similar images is achieved, thereby increasing the efficiency of image selection by the use object.

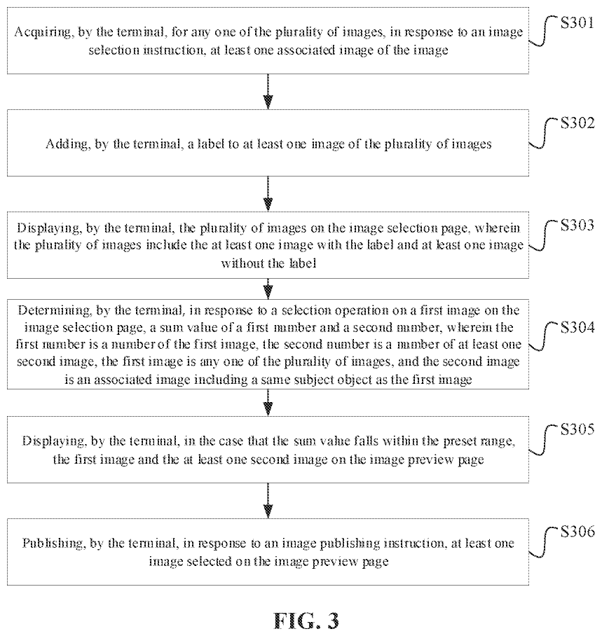

FIG. 3 is a flowchart of another method for publishing an image according to some embodiments. As shown in FIG. 3, the method is executed by a terminal or an electronic device and includes the following processes.

In S301, for any one of a plurality of images, the terminal acquires, in response to an image selection instruction, at least one associated image of the image.

In the embodiments of the present disclosure, in the case that the use object wants to publish an image, an image selection instruction is triggered by clicking an image selection control, such that at least one to-be-published image is selected from the plurality of images. The plurality of images are images stored over a historical period of time by the use object, and the plurality of images include a plurality of types, a plurality of angles, and a plurality of objects. The objects may be a person, an animal, or a thing. The objects in different images may not be identical. Many similar images may exist in the plurality of images because there are the images acquired according to different shooting modes or acquired from different shooting angles for the same object.

In some embodiments, for any one of the plurality of images, the terminal determines the at least one associated image of the image according to a storage order of the image, a storage period of time of the image, or image clustering. Accordingly, the terminal acquires the at least one associated image of the image in the following three modes to achieve the screening of the similar images.

In the first mode, the terminal acquires the at least one associated image according to the storage order of the image. Accordingly, the terminal determines, for any one of the plurality of images, at least one third image adjacent to the image according to the storage order of the image. Then, the terminal determines, from the at least one third image, the at least one associated image of the image. By acquiring the at least one associated image based on the storage order of the image, the screening of the similar images is achieved, thereby increasing the efficiency of image selection by the use object.

For example, for any one of the plurality of images, it is assumed that the subject object of the image is a dog. The terminal acquires at the first left, the first right, the first top, and the first bottom of the image as third images. Then, from the third images, the terminal acquires at least one image of the same dog as the subject object of the image, and determines the image as an associated image.

In the second mode, the terminal acquires the at least one associated image based on the storage period of time of the image. Accordingly, the terminal determines, for any one of the plurality of images, at least one fourth image in a same time range as the storage period of time of the image. Then, the terminal determines, from the at least one fourth image, at least one associated image of the image. In this mode, the time range may be one hour, one day, or one week, and the storage period of time in the same day is taken as an example for the description of the embodiments of the present disclosure. By acquiring the at least one associated image based on the storage period of time of the image, the screening of the similar images is achieved, thereby increasing the efficiency of image selection by the use object.

For example, for any one of the plurality of images, it is assumed that the storage period of time of the image is Sep. 20, 2022, and the subject object is a dog. The terminal acquires, from the plurality of images, images with the same storage period of time on Sep. 20, 2022 as fourth images. Then, the terminal acquires, from the fourth images, at least one image of the same dog as the subject object of the image described above, and determines the image as an associated image.

In the third mode, the terminal determines images belonging to a same image cluster as similar images by clustering the images, namely acquiring the at least one associated image. Accordingly, the terminal clusters the plurality of images to acquire a plurality of image clusters. The image cluster may include a number of similar images that occur together or occur in a certain time period. Then, the terminal determines a plurality of images belonging to the same image cluster as mutually associated images. By clustering the images to acquire the mutually associated images, the screening of the similar images is achieved, thereby increasing the efficiency of image selection by the use object.

In some embodiments, for any one of the plurality of images, the terminal acquires at least one image similar to the image as the at least one associated image of the image, to achieve the screening of the similar images, thereby increasing the efficiency of image selection by the use object. Accordingly, for any one of the plurality of images, the terminal determines, based on the type of the subject object in the image, the location of the subject object in the image, or the area occupied by the subject object in the image, from at least one image having the same subject object as the image, at least one associated image of the image having the similarity greater than a similarity threshold. The embodiments of the present disclosure do not limit the modes that the at least one associated image is determined.

In S302, the terminal adds a label to at least one image of the plurality of images.

In the embodiments of the present disclosure, the terminal, after determining at least one associated image of any one of the plurality of images, adds a label to at least one image of the plurality of images. The label is configured to indicate that an image with the label is different from other images. For example, the label indicates that the image has a higher definition, the subject object of the image has a higher highlighting degree, or the type of the subject object of the image, which is not limited in the embodiments of the present disclosure. By adding the label to the at least one image, the at least one image can be recommended to the use object when the use object selects an image, thereby increasing the efficiency of image selection by the use object.

In some embodiments, for at least one image of the plurality of images, the terminal adds a custom label to the image on a label adding page, adds a label to the image based on an image attribute of the image, adds a label to the image based on an image attribute of the historical published image of the use object, or adds a label to the image based on a quality parameter of the image. Accordingly, the terminal may add a label to the at least one image in the following four modes.

In the first mode, the terminal adds a custom label to the image on the label adding page. The label adding page is configured to add custom labels to a plurality of images. Accordingly, the terminal displays, in response to the image selection instruction, a plurality of images on the label adding page. Then, the terminal adds, in response to a label adding operation on any one of the plurality of images, a first label to the image. The first label is a custom label of the use object. For example, the first label is a type of a subject object of the image, a storage period of time of the image, or a text representing features of the image, which is not limited in the embodiments of the present disclosure. By adding the custom labels to the images, the personalized identification of the images can be achieved for the use object, and at least one image can be recommended to the use object when the use object selects an image, thereby increasing the efficiency of image selection by the use object.

In the second mode, the terminal adds a label to the image based on the image attribute of the image. The image attribute is configured to represent the type of the subject object in the image. Accordingly, the terminal acquires, in response to the image selection instruction, image attributes of the plurality of images. Then, for any one of the plurality of images, the terminal adds, based on the image attribute of the image, a second label to the image. The content of the second label is configured to indicate the type of image. By adding the label to the image based on the image attribute of the image, the type of the image is described by words when the use object selects an image, thereby increasing the efficiency of image selection by the use object.

For example, for any one of the plurality of images, the terminal acquires the image attribute of the image, namely, acquires the type of the subject object in the image. For example, if the subject object of the image acquired by the terminal is a dog, the terminal adds a second label to the image, the content of the second label being a dog.

In the third mode, the terminal adds a label to the image published this time based on the image attribute of the historical published image of the use object. The use object is an object triggering an image selection instruction, the historical published image is an image published by the use object in a historical period of time, and the image attribute is configured to represent the type of the subject object in the image. Accordingly, the terminal acquires, in response to the image selection instruction, the historical published image of the use object. Then, the terminal predicts, based on an image attribute of the historical published image, the at least one image published this time. Finally, the terminal adds a third label to the at least one image. The third label is configured to represent the type of the subject object in the image published this time. By adding the label to the image published this time based on the historical published image of the use object, an image of the same type as the historical published image can be recommended to the use object when the use object selects an image, thereby increasing the efficiency of image selection by the use object.

For example, it is assumed that the terminal acquires three historical published images of the use object and acquires image attributes of the three historical published images, which are a dog, a cat, and a dog, respectively. Then, the terminal predicts, based on the image attributes of the three historical published images, the image published this time or predict the image that the use object may want to publish. As the subject objects of two historical published images in the three historical published images are dogs, the terminal predicts that the subject object of the image published this time is also a dog. Then, the terminal acquires images with subject objects being dogs, and adds third labels to the images. The content of the third label is a type of the subject object, that is a dog, or is a prediction, namely, the image is an image predicted to be published, or is a recommendation, namely, the image is an image recommended to be published, which is not limited in the embodiments of the present disclosure.

In the fourth mode, the terminal adds a label to an image based on a quality parameter of the image. The quality parameter is configured to represent the quality of the image. Accordingly, the plurality of images are divided by the terminal into at least one similar image group, the similar image group including a plurality of images similar to each other. The terminal acquires, in response to the image selection instruction, quality parameters of the plurality of images. Then, for any similar image group, the terminal adds a fourth label to an image with a quality parameter greater than a parameter threshold in the similar image group. The fourth label is configured to indicate that the image has higher quality than other images. By adding the label to the images based on the quality parameters, an image with higher quality can be recommended to the use object when the use object selects an image, thereby increasing the efficiency of image selection by the use object.

In some embodiments, the terminal determines a quality parameter of the image by determining a definition parameter and a picture parameter of the image. The definition parameter is configured to represent a definition degree of an image, and the picture parameter is configured to represent a highlighting degree of a subject object in the image. Accordingly, for any one of the plurality of images, the terminal determines a definition parameter of the image. Then, the terminal determines a picture parameter of the image. Finally, the terminal determines, based on the definition parameter and the picture parameter, a quality parameter of the image. The quality parameters are determined based on the definition parameters and the picture parameters, such that the image obtained by screening has a high definition, and the subject object of the image is highlighted, thereby increasing the efficiency of image selection by the use object.

For example, for any one of the plurality of images, the terminal acquires a definition parameter by determining a definition of the image. In one example, it is assumed that the definition of the image is high, the resulting definition parameter is 80. The terminal acquires a picture parameter by determining a highlighting degree of a subject object of the image. It is assumed that the subject object of the image is highlighted, the resulting picture parameter is 75. Then, the terminal acquires the quality parameter by weighting the definition parameter and the picture parameter, or acquires the quality parameter by adding the definition parameter and the picture parameter, or acquires the quality parameter by using other operation methods. The quality parameter acquired by adding the definition parameter and the picture parameter is taken as an example for the description of the embodiments of the present disclosure. It is assumed that the parameter threshold is 100, the picture parameter of the image acquired by the terminal is 155, which is greater than the parameter threshold, so the terminal adds a fourth label to the image.

In S303, the terminal displays the plurality of images on the image selection page, wherein the plurality of images include the at least one image with the label and at least one image without the label.

In the embodiments of the present disclosure, after the terminal adds the label to the at least one image of the plurality of images, the images with the labels and other images without the labels are all displayed on the image selection page. Then, the use object selects at least one to-be-published image on the image selection page. The plurality of images are displayed on the image selection page, such that the use object can select the images, and further the images with the labels also can provide recommendations for the use object, namely, the images with the labels are recommended to the use object, thereby increasing the efficiency of image selection by the use object.

It should be noted that the images with the labels may be displayed in various manners. For example, the images with the labels may be displayed in front of the images without the labels, or are displayed in the original order of the images, or are displayed in the order of the image with the first label, the image with the second label, the image with the third label and the image with the fourth label, or, the images without the labels are not displayed on the image selection page, which is not limited in the embodiments of the present disclosure.

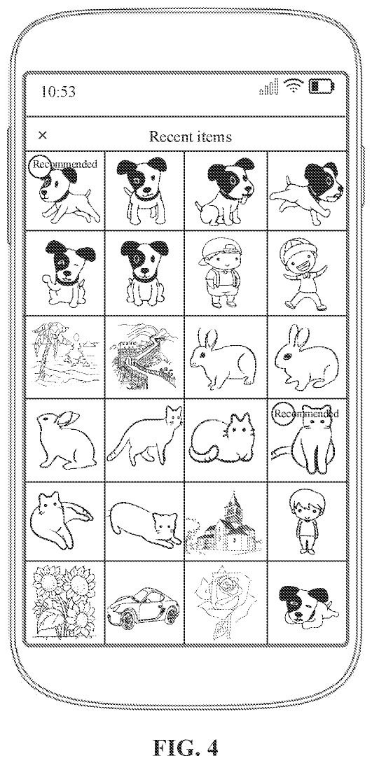

In some embodiments, FIG. 4 is a schematic diagram of an image selection page according to some embodiments. As shown in FIG. 4, the terminal displays a plurality of images on the image selection page, and the plurality of images include images with labels and images without labels.

In S304, the terminal determines, in response to a selection operation on a first image on the image selection page, a sum value of a first number and a second number, wherein the first number is a number of the first image, the second number is a number of at least one second image, the first image is any one of the plurality of images, and the second image is an associated image including a same subject object as the first image.

In the embodiments of the present disclosure, images with labels and images without labels are displayed on the image selection page, and the use object triggers the selection operation on any image to achieve the selection and preview of the image. The terminal takes the image selected by the use object as a first image, and acquires an associated image of the first image, that is, a similar image having the same subject object as the first image. Then, the terminal acquires the sum value of the number of the first image and the number of the second images. In the case that the sum value falls within a preset range, the terminal performs process S305; and in the case that the sum value does not fall within the preset range, the terminal only displays the first image on the image preview page, and continues to perform a sliding operation, a selecting operation, and a clicking operation performed on the image preview page in process S305. Through the comparison of the sum value with the preset range, the terminal displays different images on the image preview page.

In S305, the terminal displays, in the case that the sum value falls within the preset range, the first image and the at least one second image on the image preview page.

In the embodiments of the present disclosure, the preset range is configured to determine images displayed on the image preview page. In the case that the sum value of the number of the first image and the number of the second images falls within the preset range, the terminal displays the first image and the at least one second images on the image preview page; and in the case that the sum value of the number of the first image and the number of the second images does not fall within the preset range, the terminal only displays the first image on the image preview page. The images displayed on the image preview page are determined according to the sum value and the preset range, thereby increasing the efficiency of image selection by the use object.

For example, the preset range [5, 10] is taken as an example, after the use object triggers the selection operation, the terminal determines the image selected by the use object as the first image. Then, the terminal determines the number of associated images of the first image according to the above process. That is, the number of the second images is 5. The sum value of the number of the first image and the number of the second images is 6, which falls within the preset range [5, 10], and then the terminal displays the first image and the second images on the image preview page.

In some embodiments, the terminal displays, in response to the selection operation of the use object, an image switching area on the image preview page in which a thumbnail of the first image and thumbnails of the second images are displayed. Accordingly, the terminal displays, in response to the selection operation on the first image on the image selection page, the first image and the image switching area on the image preview page. Then, the terminal displays the first image and the at least one second image in a form of thumbnails in the image switching area. The first image and the second image are displayed in the form of thumbnails in the image switching area, such that the use object can switch the images in the image switching area, thereby increasing the efficiency of image selection by the use object.

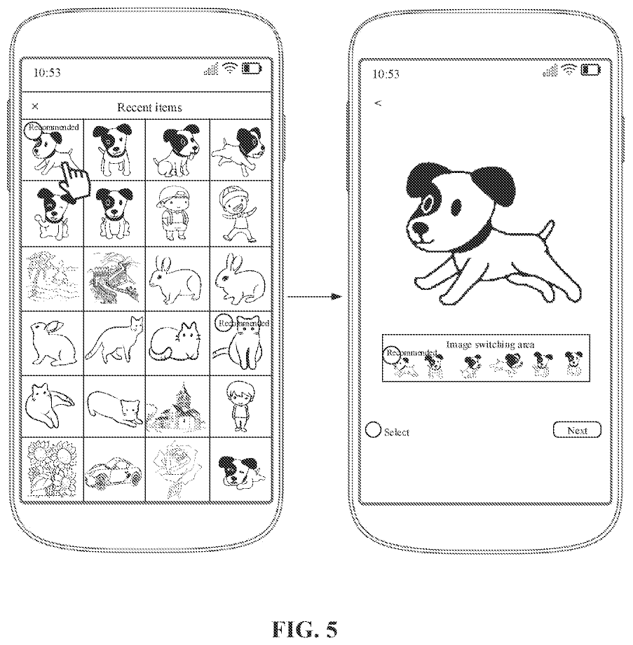

In some embodiments, FIG. 5 is a schematic diagram of an image preview page according to some embodiments. As shown in FIG. 5, the use object triggers a selection operation on an image, such that the terminal displays the image selected by the use object on the image preview page. It is assumed that the sum value of the number of the first image and the number of the second images falls within the preset range, the terminal displays the first image and the second images on the image preview page, and displays thumbnails of the first image and the second images in the image switching area. The use object performs operations on the image switching area or the image preview page to achieve the preview of different images.

In some embodiments, the use object performs operations on the image switching area or the image preview page to achieve the preview of the first image and the second images. Accordingly, the terminal displays, in response to a clicking operation on a thumbnail of any second image in the image switching area, the second image on the image preview page; or, in response to a sliding operation on the image switching area, the terminal displays a second image corresponding to a thumbnail indicated by the sliding operation on the image preview page; or, in response to a sliding operation on the image preview page, the terminal displays a second image adjacent to the first image on the image preview page. By performing operations on the image switching area and the image preview page, the method can enable preview and display the images, thereby increasing the efficiency of image selection by the use object.

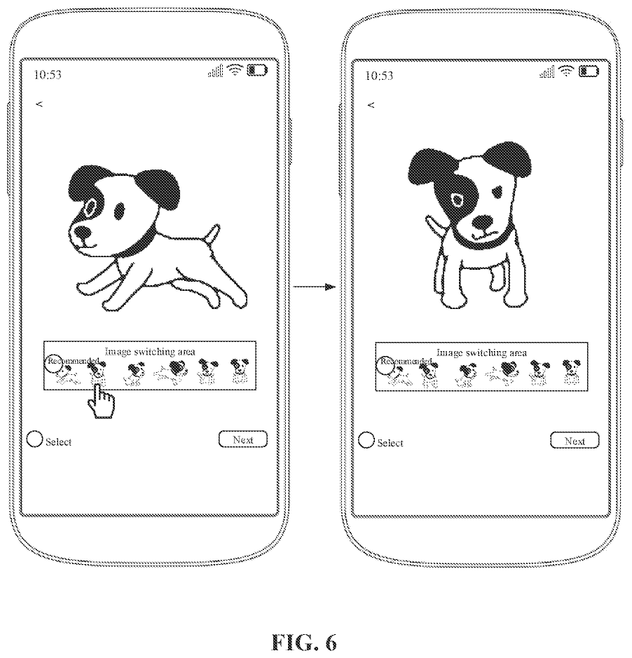

In some embodiments, FIG. 6 is a schematic diagram of a clicking operation on an image switching area according to some embodiments. As shown in FIG. 6, the use object performs a clicking operation on thumbnails of the second images in the image switching area to achieve the switching and preview of the images. After the clicking operation on the left screen illustrated in FIG. 6, the image preview page changes, and the right screen illustrated in FIG. 6 displays a second image at which the use object performs the click operation such that the user object can preview the second image on the image preview page.

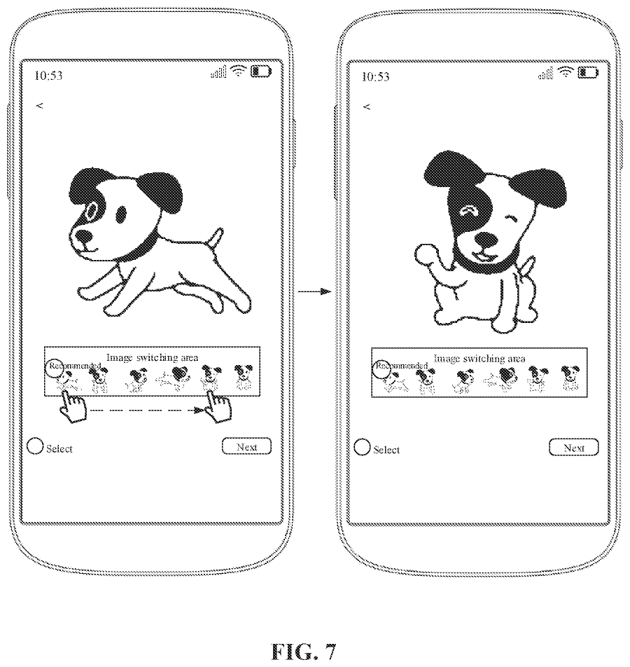

FIG. 7 is a schematic diagram of a sliding operation on an image switching area according to some embodiments. As shown in FIG. 7, the use object performs a sliding operation on thumbnails of the second images in the image switching area to achieve switching and preview of the images. After the sliding operation on the left screen illustrated in FIG. 7, the image preview page changes, and the right screen illustrated in FIG. 7 displays a second image at which the sliding operation ends or displays a second image indicated by the sliding operation on the image switching area such that the user object can preview the second image.

FIG. 8 is a schematic diagram of a sliding operation on an image preview page according to some embodiments. As shown in FIG. 8, the use object performs a sliding operation on the image switching page to achieve switching and preview of the images. As illustrated in FIG. 8, the left screen displays a recommended image (i.e., the image corresponding to an image with a “Recommended” label in the thumbnails) and also display thumbnails of the second images in the image switching area. After the sliding operation on the left screen (for example a sliding operation at a location close to the recommended image on the image preview page), the image preview page changes, and the right screen displays the second image next to the recommended image in the image switching area such that the user object can preview the next image.

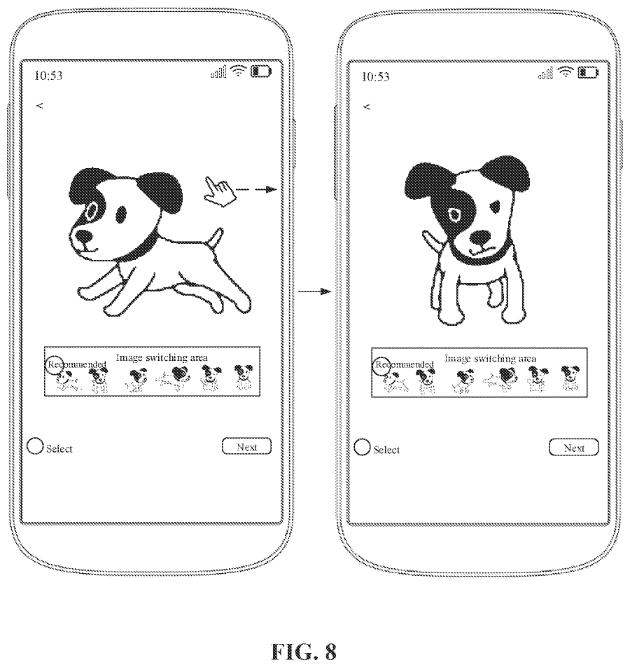

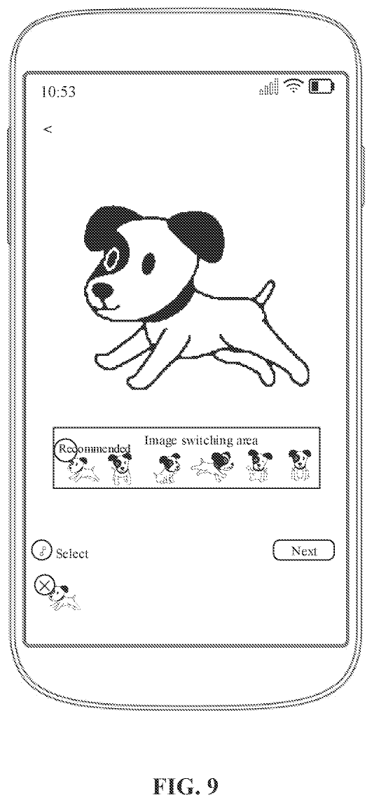

In some embodiments, FIG. 9 is a schematic diagram of a selected image state according to some embodiments. That is, FIG. 9 shows that one image is selected. As shown in FIG. 9, the use object has previewed and selected the images, and has triggered a selection operation, and after that, the terminal displays the selected image and also displays the selected image (i.e., an image labeled as “recommended”) in a form of thumbnail in an image switch area along with associated images on the image preview page.

In some embodiments, the preview page may be displayed in different manners. For example, the terminal may be configured such that in response to that the use object performs a clicking operation on a blank area, the terminal has different display effects on the image preview page. In some examples, the terminal cancels, in response to a clicking operation on a blank area on the image preview page, the display of other contents except a current image on the image preview page. Then, the terminal resumes, in response to a re-clicking operation on the blank area on the image preview page, the display of the other contents, and displays the other contents along with the current image on the image preview page, the current image being the first image or any second image. The different display effects of the image preview page are acquired by simply performing operations on the blank area, such that the use object can focus on preview on the current image if desired, thereby providing flexibility of preview and increasing the efficiency of image selection by the use object.

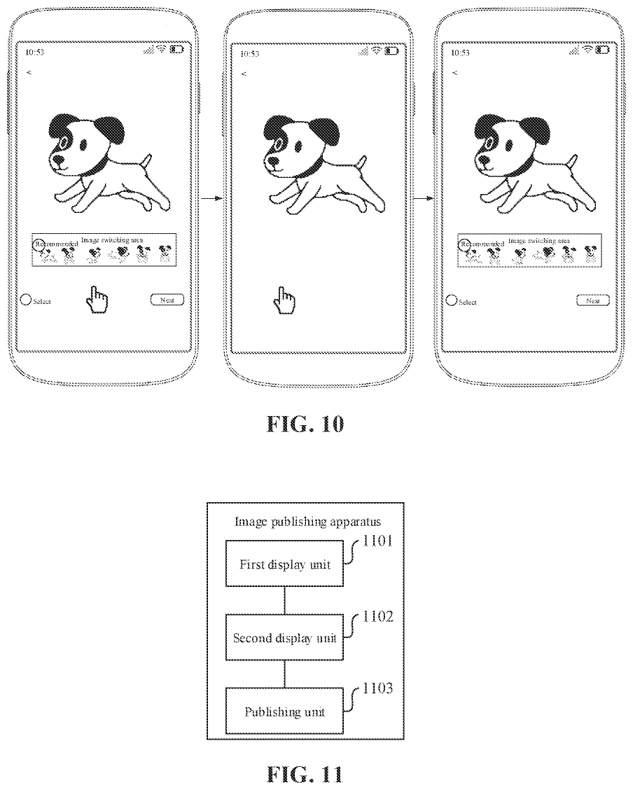

In some embodiments, FIG. 10 is a schematic diagram of a clicking operation and a re-clicking operation on a blank area according to some embodiments. As shown in FIG. 10, in the case that the use object performs a clicking operation on the blank area, the terminal cancels the display of the other contents except the current image on the image preview page or just displays the current image as shown in the middle screen in FIG. 10. In the case that the use object performs a re-clicking operation on the blank area, the terminal resumes the display of the other contents, and displays the other contents along with the current image on the image preview page. As illustrated in FIG. 10, the resumed display screen, the right screen is the same as the left screen (the display before the cancelling action).

In S306, the terminal publishes, in response to an image publishing instruction, at least one image selected on the image preview page.

In the embodiments of the present disclosure, the use object previews the first image and the at least one second image on the image preview page and selects at least one image for publishing. The terminal publishes, in response to the image publishing instruction, the image selected by the use object. The use object may publish the image in various application scenarios. For example, the use object may be an anchor in a live streaming, the anchor may publish the selected image in a live streaming page.

The embodiments of the present disclosure provide the method for publishing the image. In response to the image selection instruction, the image selection page is displayed; after the use object selects the first image on the image selection page, the first image selected by the use object and at least one second image having the same subject object as the first image is displayed on the image preview page, so as to achieve screening and displaying of the similar images; and then the use object selects at least one image on the image preview page for image publishing, thereby avoiding consuming a lot of time during image selection, and thus increasing the image publishing efficiency.

FIG. 11 is a block diagram of an apparatus for publishing an image according to some embodiments. Referring to FIG. 11, the apparatus includes a first display unit 1101, a second display unit 1102, and a publishing unit 1103.

The first display unit 1101 is configured to display, in response to an image selection instruction, a plurality of images on an image selection page.

The second display unit 1102 is configured to display, in response to a selection operation on a first image on the image selection page, the first image and at least one second image on an image preview page, wherein the first image is any one of the plurality of images, and the second image is an associated image including a same subject object as the first image.

The publishing unit 1103 is configured to publish, in response to an image publishing instruction, at least one image selected on the image preview page.

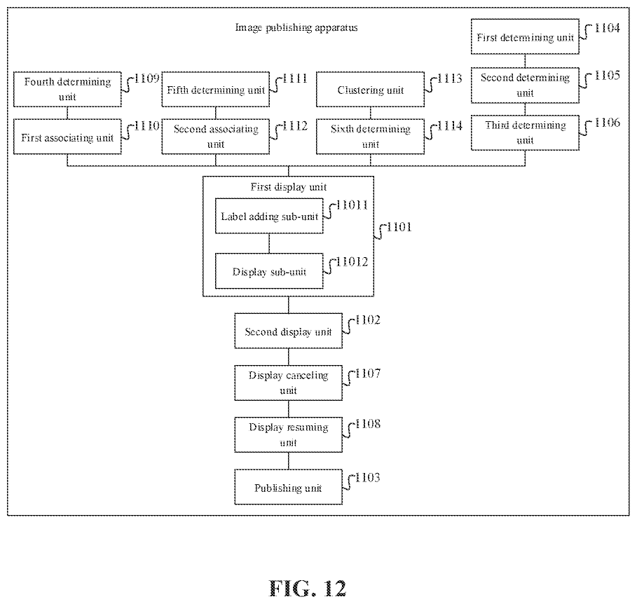

In some embodiments, FIG. 12 is a block diagram of another apparatus for publishing an image according to some embodiments. Referring to FIG. 12, the first display unit 1101 includes:

a label adding sub-unit 11011, configured to add, in response to the image selection instruction, a label to at least one image in the plurality of images; and

a display sub-unit 11012, configured to display the at least one image with the label and at least one image without the label on the image selection page.

In some embodiments, the label adding sub-unit 11011 is configured to display, in response to the image selection instruction, the plurality of images on a label adding page, wherein the label adding page is configured to add custom labels to the plurality of images; and add, in response to a label adding operation on any one of the plurality of images, a first label to the image.

In some embodiments, the label adding sub-unit 11011 is configured to acquire, in response to the image selection instruction, image attributes of the plurality of images, wherein the image attribute is configured to represent a type of a subject object in an image; and add, for any one of the plurality of images, a second label to the image based on an image attribute of the image.

In some embodiments, the label adding sub-unit 11011 is configured to acquire, in response to the image selection instruction, a historical published image of a use object, wherein the use object is an object triggering the image selection instruction, and the historical published image is an image published by the use object in a historical period of time; predict, based on an image attribute of the historical published image, the at least one image published this time, wherein the image attribute is configured to represent a type of a subject object in an image; and add a third label to the at least one image.

In some embodiments, the plurality of images are divided into at least one similar image group, the similar image group including a plurality of images similar to each other; and the label adding sub-unit 11011 is configured to acquire, in response to an image selection instruction, quality parameters of the plurality of images, wherein the quality parameter is configured to represent a quality of an image; and add, for any similar image group, a fourth label to an image with a quality parameter greater than a parameter threshold in the similar image group.

In some embodiments, referring to FIG. 12, the apparatus further includes:
a first determining unit 1104, configured to determine, for any one of the plurality of images, a definition parameter of the image, wherein the definition parameter is configured to represent a definition degree of an image;
a second determining unit 1105, configured to determine a picture parameter of the image, wherein the picture parameter is configured to represent a highlighting degree of a subject object in an image; and
a third determining unit 1106, configured to determine, based on the definition parameter and the picture parameter, a quality parameter of the image.

In some embodiments, the second display unit 1102 is configured to determine, in response to a selection operation on a first image on the image selection page, a sum value of a first number and a second number, wherein the first number is a number of the first image, and the second number is a number of at least one second image; display, in a case that the sum value falls within a preset range, the first image and the at least one second image on the image preview page; and display, in a case that the sum value does not fall within the preset range, the first image on the image preview page.

In some embodiments, the second display unit 1102 is configured to display, in response to the selection operation on the first image on the image selection page, the first image and the image switching area on the image preview page; and display the first image and the at least one second image in a form of thumbnails in the image switching area.

In some embodiments, the second display unit 1102 is further configured to display, in response to a clicking operation on a thumbnail of any second image in the image switching area, the second image on the image preview page; or display, in response to a sliding operation on the image switching area, a second image corresponding to a thumbnail indicated by the sliding operation on the image preview page; or display, in response to a sliding operation on the image preview page, a second image adjacent to the first image on the image preview page.

In some embodiments, referring to FIG. 12, the apparatus further includes:
a display canceling unit 1107, configured to cancel, in response to a clicking operation on a blank area on the image preview page, the display of other contents except a current image on the image preview page, wherein the current image is the first image or any second image; and
a display resuming unit 1108, configured to resume, in response to a re-clicking operation on the blank area on the image preview page, the display of the other contents except the current image on the image preview page.

In some embodiments, referring to FIG. 12, the apparatus further includes:
a fourth determining unit 1109, configured to determine, for any one of the plurality of images, at least one third image adjacent to the image according to a storage order of images; and
a first associating unit 1110, configured to determine, from the at least one third image, at least one associated image of the image, wherein the associated image has a same subject object as the image.

In some embodiments, referring to FIG. 12, the apparatus further includes:
a fifth determining unit 1111, configured to determine, for any one of the plurality of images, at least one fourth image in a same time range as a storage period of time of the image; and
a second associating unit 1112, configured to determine, from the at least one fourth image, at least one associated image of the image, wherein the associated image has a same subject object as the image.

In some embodiments, referring to FIG. 12, the apparatus further includes:
a clustering unit 1113, configured to acquire a plurality of image clusters by clustering the plurality of images; and
a sixth determining unit 1114, configured to determine a plurality of images belonging to a same image cluster as mutually associated images.

The embodiments of the present disclosure provide the apparatus for publishing the image. In response to the image selection instruction, the image selection page is displayed; after the use object selects the first image on the image selection page, the first image selected by the use object and at least one second image having the same subject object as the first image is displayed on the image preview page, so as to achieve screening and displaying of the similar images; and then the use object selects at least one image on the image preview page for image publishing, thereby avoiding consuming a lot of time during image selection, and thus increasing the image publishing efficiency.

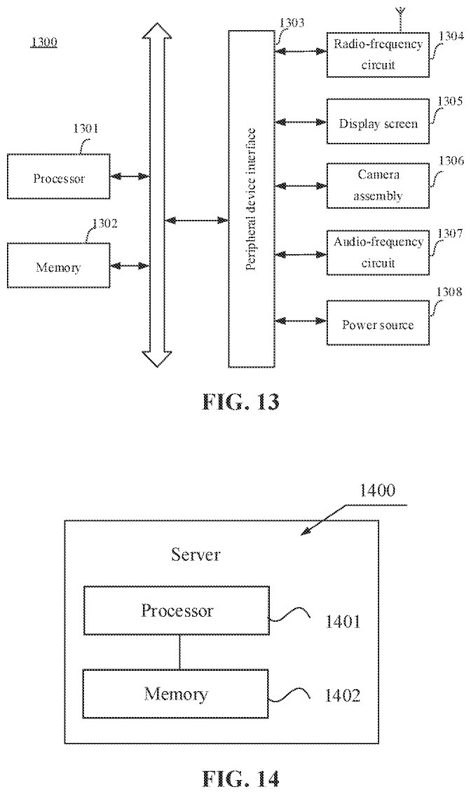

FIG. 13 is a block diagram of an electronic device 1300 according to some embodiments. Generally, the electronic device 1300 includes: a processor 1301 and a memory 1302.

The processor 1301 includes one or more processing cores, such as a 4-core processor and an 8-core processor. The processor 1301 is implemented in at least one hardware form of a digital signal processor (DSP), a field-programmable gate array (FPGA), and a programmable logic array (PLA). The processor 1301 also includes a main processor and a coprocessor. The main processor is a processor configured to process data in an awake state, and is also referred to as a central processing unit (CPU). The coprocessor is a low-power processor configured to process data in a standby state. In some embodiments, the processor 1301 is integrated with a graphics processing unit (GPU) that is responsible for rendering and drawing contents that need to be displayed on a display screen. In some embodiments, the processor 1301 further includes an artificial intelligence (AI) processor for processing computing operations related to machine learning.

The memory 1302 includes one or more computer-readable storage media, which is non-transitory. The memory 1302 further includes a high-speed random access memory, and a non-volatile memory, such as one or more magnetic disk storage devices and flash storage devices. In some embodiments, the non-transitory computer-readable storage medium in the memory 1302 is configured to store at least one program code, wherein the at least one program code, when executed by the processor 1301, causes the electronic device to perform the method for publishing the image according to the method embodiments of the present disclosure.

In some embodiments, the electronic device 1300 also optionally includes a peripheral device interface 1303 and at least one peripheral device. The processor 1301, the memory 1302, and the peripheral device interface 1303 are connected via buses or signal lines. The peripheral devices are connected to the peripheral device interface 1303 via a bus, signal line, or circuit board. Specifically, the peripheral devices include: at least one of a radio-frequency circuit 1304, a display screen 1305, a camera assembly 1306, an audio-frequency circuit 1307, and a power source 1308.

The peripheral device interface 1303 is configured to connect at least one peripheral device related to input/output (I/O) to the processor 1301 and the memory 1302. In some embodiments, the processor 1301, the memory 1302, and the peripheral device interface 1303 are integrated on the same chip or circuit board. In some other embodiments, any one or two of the processor 1301, the memory 1302, and the peripheral device interface 1303 are implemented on a separate chip or circuit board, which is not limited in the embodiments.

The radio frequency circuit 1304 is configured to receive and transmit a radio frequency (RF) signal, which is also referred to as an electromagnetic signal. The radio frequency circuit 1304 communicates with a communication network and other communication devices via electromagnetic signals. The radio frequency circuit 1304 converts an electrical signal into an electromagnetic signal for transmission, or converts a received electromagnetic signal into an electrical signal. In some embodiments, the radio frequency circuit 1304 includes an antenna system, an RF transceiver, one or more amplifiers, a tuner, an oscillator, a digital signal processor, a codec chipset, a subscriber identity module card, and the like. The radio frequency circuit 1304 communicates with other electronic devices via at least one wireless communication protocol. The wireless communication protocol includes, but is not limited to, a metropolitan area network, generations of mobile communication networks (e.g., 2G, 3G, 4G, and 5G), a wireless local area network, and/or a wireless fidelity (Wi-Fi) network. In some embodiments, the radio frequency circuit 1304 further includes a circuit related to near-field communication (NFC), which is not limited in the present disclosure.

The display screen 1305 is configured to display a user interface (UI). The UI includes graphics, text, icons, videos, and any combination thereof. In the case that the display screen 1305 is a touch display screen, the display screen 1305 also has the capacity to acquire a touch signal on or above a surface of the display screen 1305. The touch signal is input to the processor 1301 as a control signal for processing. In this case, the display screen 1305 is also configured to provide virtual buttons and/or virtual keyboards, which are also referred to as soft buttons and/or soft keyboards. In some embodiments, there is one display screen 1305 disposed on a front panel of the electronic device 1300; in some other embodiments, there are at least two display screens 1305 disposed on different surfaces of the electronic device 1300, respectively, or in a folded design; and in some still other embodiments, the display screen 1305 is a flexible display screen disposed on a curved surface or a folded surface of the electronic device 1300. The display screen 1305 is even set to a non-rectangular irregular pattern, that is, a special-shaped screen. The display screen 1305 is manufactured by using a material such as a liquid crystal display (LCD) or an organic light-emitting diode (OLED).

The camera assembly 1306 is configured to capture images or videos. In some embodiments, the camera assembly 1306 includes a front camera and a rear camera. Generally, the front camera is disposed on the front panel of the electronic device, and the rear camera is disposed on the rear surface of the electronic device. In some embodiments, there are at least two rear cameras, which are any one of a primary camera, a depth of field camera, a wide-angle camera, and a telephoto camera, such that the primary camera and the depth of field camera are combined to implement a bokeh function, the primary camera and the wide-angle camera are combined to implement panoramic shooting and virtual reality (VR) shooting functions, or other combined shooting functions are implemented. In some embodiments, the camera assembly 1306 further includes a flash. The flash is a single-color temperature flash or a two-color temperature flash. The two-color temperature flash is a combination of a warm-light flash and a cold-light flash, and is employed for light compensation at different color temperatures.

The audio-frequency circuit 1307 includes a microphone and a speaker. The microphone is configured to acquire sound waves from users and environments, and convert the sound waves into electrical signals, which are then input to the processor 1301 to be processed, or input to the radio frequency circuit 1304 for voice communication. For stereo acquisition or noise reduction, there are a plurality of microphones disposed at different parts of the electronic device 1300. The microphone is also an array microphone or an omnidirectional acquisition microphone. The speaker is configured to convert the electrical signal from the processor 1301 or the radio frequency circuit 1304 into sound waves. The speaker is a traditional thin-film speaker or a piezoelectric ceramic speaker. In the case that the speaker is a piezoelectric ceramic speaker, the electric signals may be converted into sound waves not only human-audible sound waves, but also the sound waves which are inaudible to human beings for distance measurement and the like. In some embodiments, the audio-frequency circuit 1307 is also include a headphone jack.

The power source 1308 is configured to supply power for various components in the electronic device 1300. The power source 1308 is an alternating current, a direct current, a disposable battery, or a rechargeable battery. In the case that the power source 1308 includes a rechargeable battery, the rechargeable battery supports wired charging or wireless charging. The rechargeable battery is also configured to support the fast charging technology.

Those skilled in the art can understand that the structure illustrated in FIG. 13 does not constitute limitation of the electronic device 1300, and the electronic device includes more or fewer components than those illustrated, or some of the components are combined, or a different arrangement of components is employed.

In the case that the computer device is configured as a server, FIG. 14 is a schematic structural diagram of a server according to some embodiments. The server 1400 varies greatly depending on configuration or performance, and includes one or more central processing units (CPUs) 1401 and one or more memories 1402. The memory 1402 stores at least one computer program therein. The at least one computer program, when loaded and executed by the processor 1401, causes the computer device to perform the method for publishing the image according to the method embodiments as described above. In addition, the server further has a wired or wireless network interface, a keyboard, an input/output interface, and other components to facilitate input and output. The server further includes other components for implementing functions of the device, which are not repeated here.

In some embodiments, a computer-readable storage medium including at least one instruction is further provided, such as a memory 1302 including at least one instruction. The at least one instruction, when executable by a processor 1301 of an electronic device 1300, causes the processor 1301 of the electronic device 1300 to perform the method for publishing the image as described above. In some embodiments, the computer-readable storage medium is ROM, random-access memory (RAM), CD-ROM, magnetic tape, floppy disk, optical data storage device, and the like.

In some embodiments, a computer program product including a computer program is further provided. The computer program, when executed by a processor, causes the electronic device to perform the method for publishing the image as described above.

Other embodiments of the present disclosure are apparent to those skilled in the art from consideration of the specification and practice of the present disclosure disclosed herein. The present disclosure is intended to cover any variations, uses, or adaptations of the present disclosure following the general principles of the present disclosure and including known common knowledge or customary technical means undisclosed in the art of the present disclosure. The specification and embodiments are only considered as exemplary, and a true scope and spirit of the present disclosure are indicated in the following claims.

It will be understood that the present disclosure is not limited to the precise arrangements that have been described above and shown in the accompanying drawings, and that various modifications and changes are made without departing from the scope thereof. The scope of the present disclosure is limited only by the appended claims.

What is claimed is:

1. A method for publishing an image, performed by an electronic device, the method comprising:
displaying, in response to an image selection instruction, a plurality of images on an image selection page;
acquiring, in response to a selection operation on a first image on the image selection page, at least one second image, wherein the first image is any one of the plurality of images, and the second image is an associated image comprising a same subject object as the first image;
displaying, on an image preview page, the first image and the at least one second image; and
publishing, in response to an image publishing instruction, at least one image selected on the image preview page.

2. The method for publishing the image according to claim 1, wherein displaying, in response to the image selection instruction, the plurality of images on the image selection page comprises:
adding, in response to the image selection instruction, a label to at least one image in the plurality of images, wherein label is configured to indicate that an image with the label is different from other images; and
displaying the at least one image with the label and at least one image without the label on the image selection page.

3. The method for publishing the image according to claim 2, wherein adding, in response to the image selection instruction, the label to the at least one image in the plurality of images comprises:
displaying, in response to the image selection instruction, the plurality of images on a label adding page, wherein the label adding page is configured to add custom labels to the plurality of images; and
adding, in response to a label adding operation on any one of the plurality of images, a first label to the image, wherein the first label indicates a type of a subject object of the image, a storage period of time of the image, or a text representing features of the image.

4. The method for publishing the image according to claim 2, wherein adding, in response to the image selection instruction, the label to the at least one image in the plurality of images comprises:
acquiring, in response to the image selection instruction, image attributes of the plurality of images, wherein the image attribute is configured to represent a type of a subject object in an image; and
adding, for any one of the plurality of images, a second label to the image based on an image attribute of the image, wherein a content of the second label indicates a type of image.

5. The method for publishing the image according to claim 2, wherein adding, in response to the image selection instruction, the label to the at least one image in the plurality of images comprises:
acquiring, in response to the image selection instruction, a historical published image of a use object, wherein the use object is an object triggering the image selection instruction, and the historical published image is an image published by the use object in a historical period of time;
predicting, based on an image attribute of the historical published image, the at least one image published this time, wherein the image attribute is configured to represent a type of a subject object in an image; and
adding a third label to the at least one image.

6. The method for publishing the image according to claim 2, wherein the plurality of images are divided into at least one similar image group, the similar image group comprising a plurality of images similar to each other; and
adding, in response to the image selection instruction, the label to the at least one image in the plurality of images comprises:
acquiring, in response to the image selection instruction, quality parameters of the plurality of images, wherein the quality parameter is configured to represent a quality of an image; and
adding, for any similar image group, a fourth label to an image with a quality parameter greater than a parameter threshold in the similar image group.

7. The method for publishing the image according to claim 6, further comprising:
determining, for any one of the plurality of images, a definition parameter of the image, wherein the definition parameter is configured to represent a definition degree of an image; and
determining a picture parameter of the image, wherein the picture parameter is configured to represent a highlighting degree of a subject object in an image;
wherein the quality parameter is determined based on the definition parameter and the picture parameter.

8. The method for publishing the image according to claim 1, wherein displaying, in response to the selection operation on the first image on the image selection page, the first image and the at least one second image on the image preview page comprises:
determining, in response to the selection operation on the first image on the image selection page, a sum value of a first number and a second number, wherein the first number is a number of the first image, and the second number is a number of the at least one second image;
displaying, in a case that the sum value falls within a preset range, the first image and the at least one second image on the image preview page; and
displaying, in a case that the sum value does not fall within the preset range, the first image on the image preview page.

9. The method for publishing the image according to claim 1, wherein displaying, in response to the selection operation on the first image on the image selection page, the first image and the at least one second image on the image preview page comprises:
displaying, in response to the selection operation on the first image on the image selection page, the first image and an image switching area on the image preview page; and
displaying the first image and the at least one second image in a form of thumbnails in the image switching area.

10. The method for publishing the image according to claim 9, further comprising:
displaying, in response to a clicking operation on a thumbnail of any second image in the image switching area, the second image on the image preview page; or
displaying, in response to a sliding operation on the image switching area, a second image corresponding to a thumbnail indicated by the sliding operation on the image preview page; or
displaying, in response to a sliding operation on the image preview page, a second image adjacent to the first image on the image preview page.

11. The method for publishing the image according to claim 1, further comprising:
canceling, in response to a clicking operation on a blank area on the image preview page, display of other contents except a current image on the image preview page, and displaying only the current image, wherein the current image is the first image or any second image; and
resuming, in response to a re-clicking operation on the blank area on the image preview page, the display of the other contents on the image preview page along with the current image.

12. The method for publishing the image according to claim 1, wherein acquiring, in response to a selection operation on the first image on the image selection page, at least one second image comprising:
determining, for any one of the plurality of images, at least one third image adjacent to the first image according to a storage order of images; and
determining, from the at least one third image, at least one associated image of the image as the second image, wherein the associated image has a same subject object as the image.

13. The method for publishing the image according to claim 1, wherein acquiring, in response to a selection operation on the first image on the image selection page, at least one second image comprising:
determining, for any one of the plurality of images, at least one fourth image in a same time range as a storage period of time of the first image; and
determining, from the at least one fourth image, at least one associated image of the image as the second image, wherein the associated image has a same subject object as the image.

14. The method for publishing the image according to claim 1, acquiring, in response to a selection operation on the first image on the image selection page, at least one second image comprising:
acquiring a plurality of image clusters by clustering the plurality of images; and
determining a plurality of images belonging to a same image cluster as mutually associated images and as the second images.

15. An electronic device, comprising:
one or more processors; and
a memory for storing a program code executed by the one or more processors;
wherein the one or more processors are configured to execute the program code to perform:
displaying, in response to an image selection instruction, a plurality of images on an image selection page;
displaying, in response to a selection operation on a first image on the image selection page, the first image and at least one second image on an image preview page, wherein the first image is any one of the plurality of images, and the second image is an associated image comprising a same subject object as the first image; and
publishing, in response to an image publishing instruction, at least one image selected on the image preview page.

16. The electronic device according to claim 15, wherein the one or more processors are configured to execute the program code to perform:
adding, in response to the image selection instruction, a label to at least one image in the plurality of images; and
displaying the at least one image with the label and at least one image without the label on the image selection page.

17. The electronic device according to claim 16, wherein the one or more processors are configured to execute the program code to perform:
displaying, in response to the image selection instruction, the plurality of images on a label adding page, wherein the label adding page is configured to add custom labels to the plurality of images; and
adding, in response to a label adding operation on any one of the plurality of images, a first label to the image.

18. The electronic device according to claim 16, wherein the one or more processors are configured to execute the program code to perform:
acquiring, in response to the image selection instruction, image attributes of the plurality of images, wherein the image attribute is configured to represent a type of a subject object in an image; and
adding, for any one of the plurality of images, a second label to the image based on an image attribute of the image.

19. The electronic device according to claim 16, wherein the one or more processors are configured to execute the program code to perform:
acquiring, in response to the image selection instruction, a historical published image of a use object, wherein the use object is an object triggering the image selection instruction, and the historical published image is an image published by the use object in a historical period of time;
predicting, based on an image attribute of the historical published image, the at least one image published this time, wherein the image attribute is configured to represent a type of a subject object in an image; and
adding a third label to the at least one image.

20. The electronic device according to claim 16, wherein the plurality of images are divided into at least one similar image group, the similar image group comprising a plurality of images similar to each other; and
the one or more processors are configured to execute the program code to perform:
acquiring, in response to the image selection instruction, quality parameters of the plurality of images, wherein the quality parameter is configured to represent a quality of an image; and
adding, for any similar image group, a fourth label to an image with a quality parameter greater than a parameter threshold in the similar image group.
